(19) United States
(12) Patent Application Publication
(10) Pub. No.: US 2024/0320582 A1
(43) Pub. Date: Sep. 26, 2024

(54) SYSTEMS AND METHODS FOR PLANNING TRANSIT SYSTEMS CONTAINING FIXED ROUTE AND ON-DEMAND SERVICES

(71) Applicant: VIA TRANSPORTATION, INC., New York, NY (US)

(72) Inventors: Yaron TAUB, Ramat Gan (IL); Elad BERKMAN, Giv'atayim (IL); Oshri MACHLUF, Ramat Gan (IL)

(73) Assignee: VIA TRANSPORTATION, INC., New York, NY (US)

(21) Appl. No.: 18/611,259

(22) Filed: Mar. 20, 2024

Related U.S. Application Data
(60) Provisional application No. 63/491,122, filed on Mar. 20, 2023.

(51) Int. Cl. G06Q 10/0631; G06Q 10/04; G06Q 50/47

(52) U.S. Cl. CPC G06Q 10/06315; G06Q 10/04; G06Q 10/06312; G06Q 50/47

(57) ABSTRACT

Systems and methods for planning a public transit system including determining costs of providing a fixed-route service are provided. The systems and method can receive a set of fixed route lines and trips for the public transit system and a plurality of ride requests. The systems and method can include determining a plurality of possible proposals for each ride request of the plurality of ride requests based on the received set of fixed route lines and trips and/or one or more constraints, determine for each ride request a set of proposals of the plurality of proposals having the lowest overall cost to provide the fixed-route service and determine whether one or more of a subset of the fixed route lines or trips are to be removed from the received set of fixed route lines and trips.

### CROSS REFERENCE TO RELATED APPLICATIONS

This application claims the benefit of and priority to U.S. Provisional Patent Application No. 61/766,869, filed Mar. 20, 2023, the entire contents of which are owned by the assignee of the instant application and incorporated herein by reference in their entirety.

### FIELD OF THE INVENTION

The invention relates generally to transit planning, vehicle ridesharing and systems and methods for transit planning management.

### BACKGROUND OF THE INVENTION

Recent years have witnessed increasing interest and development in the field of vehicle sharing, where one or more riders may share the same vehicle for a portion of their rides. Ridesharing may save ride costs, increase vehicle utilization, and reduce air pollution. A rider may use a ridesharing service through a ridesharing service application accessed by the rider's mobile device or by talking to an operator.

Typically, ridesharing management systems are on-demand services, such that a rider requests a ride from pick-up location to a drop-off location. Ridesharing management systems can also incorporate public transportation options. Public transportation systems can include fixed routes. The vehicle can make multiple stops along a fixed route (e.g., a bus along a bus route).

A high-capacity vehicle driving a fixed route can be well suited to a public-transit demand pattern, efficient in aggregating passengers. However, public-transit can have a demand that is not easily aggregated (e.g., due to spareness in space or time). Accordingly, public-transit can suffer from low vehicle utilization and/or high rider travel duration (e.g., due to high detours required to aggregate riders, high level of walking, and/or high level of waiting resulting from sparsity of service).

Therefore, it can be desirable to improve vehicle utilization and/or rider travel duration in fixed route transit systems.

### SUMMARY

Advantage of the invention can include more accurate rideshare planning, an ability to reduce the number of vehicles needed and the operational costs, improve vehicle utilization, improve rider travel duration in fixed route transit systems, reduction in rider wait times at transportation hubs, or any combination thereof.

Advantages of the invention can include combined fixed route and on-demand vehicle planning, determining plans that have reduced cost, and/or better serve ridership demand.

In one aspect, the invention can involve a method for planning a public transit system comprising determining costs of providing a fixed-route service. The method can involve receiving, via a computing device, a set of fixed route lines and trips for a particular public transit system. The method can involve receiving, via the computing device, a plurality of ride requests, each ride request comprising a start location, a start or end time, and an end location. The method can involve determining, via the computing device, a plurality of possible proposals for each ride request of the plurality of ride requests based on the received set of fixed route lines and trips, the start location, the start time, the end location of each of the ride requests and one or more constraints. The method can involve determining, via the computing device, for each ride request of the plurality of ride requests, a set of proposals of the plurality of proposals having the lowest overall cost to provide the fixed-route service. The method can involve determining, via the computing device, whether one or more of a subset of the fixed route lines or trips are to be removed from the received set of fixed route lines and trips, and whether the remaining fixed route lines and trips are to be adjusted in time. The method can involve transmitting, via the computing device, the set proposals for each ride request, and the remaining fixed route lines and trips to a display, to a transit system, to a ride sharing management system or any combination thereof.

In some embodiments, the method involves outputting the public transit system timetables, vehicle frequency, or any combination thereof. In some embodiments, the one or more constraints include a number of assignments per trip does not exceed a predetermined limit per trip, if a trip is assigned to a request, then a corresponding return trip is automatically assigned when the fixed route line operates the same route in two directions, if a trip is assigned to a request, then activate the fixed route line, or any combination thereof.

In some embodiments, the method involves determining, the set of proposals for each request further comprises using a mixed integer linear program based on the plurality of solutions.

In some embodiments, the method involves determining the overall cost comprises a) summing fixed route trip durations multiplied by fixed route trip's total operational cost over all fixed route trips used, b) summing costs for each fixed-route, c) summing for all rides total trip duration multiplied by value of travel time, and d) summing outcomes of a) b) and c).

In some embodiments, the method involves determining for at least some of the ride requests an on-demand proposal, determining a cost of providing the proposals for each ride request based on the fixed-service proposal and the on-demand proposal, and selecting one proposal of the plurality of proposals based on the overall cost.

In some embodiments, the method involves determining the cost of the fixed-route and on-demand proposals by a) summing fixed route trip duration multiplied by fixed route trip's total operational cost over all fixed route trips used, b) summing costs for each fixed route, c) summing on-demand trip durations multiplied by on-demand van time cost over all on-demand trips, and adding an overhead for operating an on-demand service, d) summing for all rides total trip duration multiplied by value of travel time, and e) summing outcomes of a) b) c) and d).

In another aspect, the invention includes a system for planning a public transit system comprising determining costs of providing a fixed-route service. The system includes at least one processor configured to receive a set of fixed route lines and trips for a particular public transit system, receive a plurality of ride requests, each ride request comprising a start location, a start or end time, and an end location, and determine a plurality of possible proposals for each ride request of the plurality of ride requests based on the received set of fixed route lines and trips, the start location, the start time, the end location of each of the ride requests and one or more constraints. The at least one processor can also be configured to determine for each ride request of the plurality of ride requests, a set of proposals of the plurality of proposals having the lowest overall cost to provide the fixed-route service, determine whether one or more of a subset of the fixed route lines or trips are to be removed from the received set of fixed route lines and trips, and whether the remaining fixed route lines and trips are to be adjusted in time, and transmit the set proposals for each ride request, and the remaining fixed route lines and trips to a display, to a transit system, to a ride sharing management system or any combination thereof.

In some embodiments, the system includes at least one processor is further configured to output the public transit system timetables, vehicle frequency, or any combination thereof. In some embodiments, wherein the one or more constraints include a number of assignments per trip does not exceed a predetermined limit per trip, if a trip is assigned to a request, then a corresponding return trip is automatically assigned when the fixed route line operates the same route in two directions, if a trip is assigned to a request, then activate the fixed route line, or any combination thereof.

In some embodiments, wherein the at least one processor is further configured to determine the set of proposals for each request further comprises using a mixed integer linear program based on the plurality of solutions. In various embodiments, the set of proposals is determined by linear programming, quadratic programming, convex optimization or any combination thereof.

In some embodiments, wherein determining the overall cost comprises a) sum fixed route trip durations multiplied by fixed route trip's total operational cost over all fixed route trips used, b) sum costs for each fixed-route, c) sum for all rides total trip duration multiplied by value of travel time, and d) sum outcomes of a) b) and c).

In some embodiments, wherein the at least one processor is further configured to determine for at least some of the ride requests an on-demand proposal, determine a cost of providing the proposals for each ride request based on the fixed-service proposal and the on-demand proposal, and select one proposal of the plurality of proposals based on the overall cost.

In some embodiments, the at least one processor is further configured to determine the cost of the fixed-route and on-demand proposals includes a) sum fixed route trip duration multiplied by fixed route trip's total operational cost over all fixed route trips used, b) sum costs for each fixed route, c) sum on-demand trip durations multiplied by on-demand van time cost over all on-demand trips, and adding an overhead for operating an on-demand service, d) sum for all rides total trip duration multiplied by value of travel time, and e) sum outcomes of a) b) c) and d).

In another aspect, the invention includes one or more non-transitory computer-readable storage media comprising instructions that are executable to cause one or more processors to receive a set of fixed route lines and trips for a particular public transit system, receive a plurality of ride requests, each ride request comprising a start location, a start or end time, and an end location, and determine a plurality of possible proposals for each ride request of the plurality of ride requests based on the received set of fixed route lines and trips, the start location, the start time, the end location of each of the ride requests and one or more constraints. The one or more processors can be further configured to determine for each ride request of the plurality of ride requests, a set of proposals of the plurality of proposals having the lowest overall cost to provide the fixed-route service, determine whether one or more of a subset of the fixed route lines or trips are to be removed from the received set of fixed route lines and trips, and whether the remaining fixed route lines and trips are to be adjusted in time, and transmit the set proposals for each ride request, and the remaining fixed route lines and trips to a display, to a transit system, to a ride sharing management system or any combination thereof.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features and advantages thereof, can be understood by reference to the following detailed description when read with the accompanied drawings. Embodiments of the invention are illustrated by way of example and not limitation in the figures of the accompanying drawings, in which like reference numerals indicate corresponding, analogous or similar elements, and in which:

FIG. 1 is a diagram of a ridesharing management system, according to some embodiments of the invention.

FIG. 2 shows an example of an architecture for a ridesharing management server, according to some embodiments of the invention.

FIG. 3 shows a flowchart for a method for planning a public transit system comprising determining costs of providing a fixed route service, according to some embodiments of the invention.

FIG. 4 is a diagram showing an example of an output with fixed route only according to some embodiments of the invention.

FIG. 5 is a diagram showing an example of an output with fixed route only according to some embodiments of the invention.

FIG. 6 is a diagram showing an example of an output with fixed route and on-demand according to some embodiments of the invention.

FIG. 7 shows a block diagram of a computing device which can be used with embodiments of the invention.

### DETAILED DESCRIPTION

In the following detailed description, numerous specific details are set forth in order to provide a thorough understanding of the invention. However, it will be understood by those skilled in the art that the present invention can be practiced without these specific details. In other instances, well-known methods, procedures, and components, modules, units and/or circuits have not been described in detail so as not to obscure the invention.

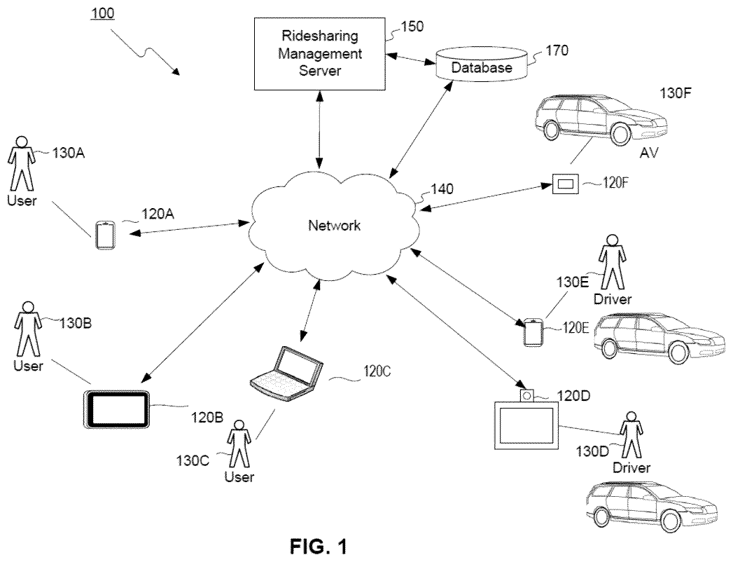

FIG. 1 is a diagram of a ridesharing management system 100, according to some embodiments of the invention. The ridesharing management system 100 includes one or more user devices 120A-120F (collectively referred to as user devices 120) associated with respective users 130A-130F, a network 140, a ridesharing management server 150, and a database 170. The user devices 120 can be communications devices (e.g., land line phones and/or mobile devices), personal computers, tablets, laptops, or any combination thereof.

The users 130A-130F can be riders, drivers, transit planners and/or other computing systems. In FIG. 1, users 130A-130B are riders, user 130C is a transit planner, users 130D-130E are drivers, and user 130F is an autonomously driven vehicle user. The user devices 120A-120F can be associated with riders, drivers, and/or other computing systems, such that user devices 120A-120B can be referred to as rider devices, user device 120C can be a transit planner device, user devices 120D-120E can be referred to as driver devices, and user device 120F can be referred to as a driving-control device.

The network 140 can be coupled to the user devices 120 to facilitate communications between the user devices 120 and the ridesharing management server 150. For example, the transit planner 130C can input a plurality of ride requests (e.g., ride requests that occurred in the transit planner's public transit system) and the ridesharing management service 150 can determine a transit plan for the transit planner 130C. In another example, the rider 130A can request a ride via the rider device 120A that is a smart phone. The request can be transmitted by the user device 120A to the ridesharing management server 150 through the network 140. The ridesharing management server 150 can transmit a route to the driver device 120E (e.g., on-demand vehicle) to instruct the driver 130E to pick-up the rider 130A. The ridesharing management server 150 can transmit a message to the rider 130A via the rider device 120A indicating that the driver 130E is on its way and the message can instruct the rider 130A to a particular pick-up location.

The network 140 can facilitate communications that include receiving ride requests and/or other ride related input from or sending confirmations to the rider devices 120A-120B and/or sending ride service assignments to the driver devices 120D-120E and driving-control device 120F.

The network 140 can be any type of network that provides communications, exchanges information, and/or facilitates the exchange of information between ridesharing management server 150 and user devices 120. For example, network 140 can be the Internet, a Local Area Network, a cellular network, a public switched telephone network (“PSTN”), and/or other suitable connection(s) that enables ridesharing management system 100 to send and/or receive information between the components of the ridesharing management system 100. The network 140 can be wired and/or wireless depending on the type of connection to the network 140. Although the network 140 is shown herein as a cloud, the network 140 can include a variety of computing components, including wired and wireless components that in various networked configurations to facilitate desired communication between components.

The network 140 can support a variety of messaging formats as is known in the art, and may support a variety of services and applications for user devices 120. For example, the network 140 can support navigation services for user devices 120, such as directing users and/or ridesharing service vehicles to pick-up and/or drop-off locations.

The ridesharing management server 150 can be a system that communicates with and/or is part of a communication service provider which provides a variety of data or services, such as voice, messaging, real-time audio/video, to users, such as users 130A-130E. The ridesharing management server 150 can be a computer-based system including computer system components, desktop computers, workstations, tablets, handheld mobile communications devices, memory devices, and/or internal network(s) connecting the components.

The ridesharing management server 150 can receive information from user devices 120 over the network 140, process the information, store the information, and/or transmit information to mobile communications devices 120 over network 140. The ridesharing management server 150 can receive ride requests from user devices 120A-120C. The ridesharing management server 150 can send ride confirmation and/or ride fare information to user devices 120A-120C. The ridesharing management server 150 can send ride service assignments (e.g., including pick-up and/or drop-off location information) to driver devices 120D and 120E, and driving-control device 120F.

The ridesharing management server 150 can receive user input from user devices 120A-120C. For example, the ridesharing management server 150 can receive various ride service parameters, such as walking distance to a pick-up location, maximum delay of arrival/detour, and/or maximum number of subsequent pick-ups.

The rideshare vehicle can be a car, van, SUV, truck, bus, or any kind of vehicle suitable for human transportation. In some embodiments, a vehicle is a taxi. In some embodiments, a rideshare vehicle can be an autonomous vehicle, wherein a control device integrated with the vehicle, or a management system separate from the vehicle can send operational messages.

The ridesharing management server 150 can calculate ride fares based on a solo portion of a user's ride and a shared portion of the ride. The ride fare calculation can be based on various ride service parameters set by the user, such as the walking distance involved in the ride, and/or user selection regarding toll road usage.

The database 170 may include one or more physical and/or virtual storages coupled with the ridesharing management server 150. The database 170 can store user account information (e.g., registered rider and/or driver accounts) and/or corresponding user profiles (e.g., contact information, profile photos, and/or associated mobile communications device information). User account information for a rider can include ride history, service feedback, complaints, and/or comments. User account information for a driver can include number of ride service assignments completed, ratings, and/or ride service history information. The database 170 can store various ride requests received from user devices 120A-120C. Each ride request can include a corresponding starting point and desired destination information, user input regarding various service parameters, pick-up and drop-off locations, time of pick-up and drop-off, ride fares, and/or other user feedback (e.g., user comments).

The database 170 may include traffic data, maps, and/or toll road information, which may be used for ridesharing service management. The traffic data may include historical traffic data and/or real-time traffic data regarding a certain geographical region. The traffic data may be used to determine traffic conditions. Traffic data and traffic conditions can be used to estimate pick-up and drop-off times for riders and/or determine an optimal route for a particular ride or for all rides. The real-time traffic data may be received from a real-time traffic monitoring system, which may be integrated into or independent from ridesharing management system 100.

The maps may include map information (e.g., roads, streets and/or distances) typically used for navigation purposes. The map information can be used to determine potential routes and in transit routes for the rideshare vehicles and/or guiding the users to a pick-off or drop-off location. Guiding the users to a pick-up or drop-off location can include displaying a map, outputting audio, displaying a list of directions or any combination thereof. The in-transit routes can be modified based on adding or reducing passengers, the driver driving off the route, speed and/or other updates. Toll road information may include amount of toll charges regarding certain roads, and any change or updates thereof. Toll road information may be used to calculate ride fares. In some embodiments, a rider can specify that the rideshare vehicle route avoids toll roads.

The data stored in database 170 can be transmitted to the ridesharing management server 150 for accommodating ride requests. In some embodiments, database 170 is stored in a cloud-based server (not shown) that is accessible by the ridesharing management server 150 and/or user devices 120 through the network 140. In some embodiments, the database 170 reside within the ridesharing management server 150.

During operation, the ridesharing management server 150 can communicate with the driving-control device 120F to direct the autonomous vehicle 130F to pick-up and drop-off riders 130A-130B. In some embodiments, autonomous vehicles capable of detecting objects on the road and navigate to designated locations may be utilized for providing ridesharing services.

In various embodiments, the ridesharing management server 150 is implemented on a single server or on multiple servers. Each server can be on a single computing device or distributed among multiple computing devices. In various embodiments, the ridesharing management system 100 includes multiple ridesharing management servers, and each ridesharing management server can serve a category of ridesharing services, ridesharing services associated with a certain category of service vehicles, and/or ridesharing services in a specific geographical region. For example, a first ridesharing management server can direct a first fleet of vehicles, a second ridesharing management server can direct a second fleet of vehicles and a third ridesharing server can direct a third fleet of vehicles. The first, second and third fleet of vehicles can be on-demand services, fixed route services, or any combination thereof.

In some embodiments, a plurality of ridesharing management servers collectively provides a dynamic and integrated ridesharing service system.

As shown in FIG. 1, users 130A-130E may include a plurality of users 130A-130C, and a plurality of drivers 130D and 130E, who may communicate with one another, and with ridesharing management server 150 using various types of user devices 120 that are mobile communications devices. For example, the mobile communications device can include a display such as a television, tablet, computer monitor, video conferencing console, or laptop computer screen. A mobile communications device 120 can further include video/audio input devices such as a microphone, video camera, keyboard and/or web camera. A mobile communications device 120 can include mobile devices such as a tablet or a smartphone having display and/or video/audio capture capabilities. The mobile communications device can include one or more software applications that can facilitate the mobile communications devices to engage in communications, such as IM, VOIP, video conferences. For example, user devices 130A-130C can send requests to ridesharing management server 150, and receive confirmations therefrom. Drivers 130D and 130E can use their respective user devices to receive ride service assignments and navigation information from ridesharing management server 150, and may contact the users with their respective user devices.

In some embodiments, a user may directly hail a vehicle by hand gesture or verbal communication, such as traditional street vehicle hailing. In such embodiments, once a driver accepts the request, the driver can use his respective user device to input the ride request information. Ridesharing management server 150 can receive the information, and accordingly assign one or more additional ride service assignments to the same vehicle, for example, subsequent ride requests received from other user devices 120 through network 140.

In some embodiments, driver devices 120D and 120E, and driving-control device 120F may be embodied in a vehicle control panel, as a part of the vehicle control system associated with a particular vehicle. For example, a traditional taxi company may install a drive device in all taxi vehicles managed by the taxi company. In some embodiments, driver devices 120D and 120E, and driving-control device 120F, may be further coupled with a payment device, such as a card reader installed as a part of the vehicle control panel or as a separate device associated with the vehicle. A user may then use the payment device as an alternative payment mechanism. For example, a user who hails the taxi on the street may pay through the payment device, without using a user device providing ridesharing service.

The ridesharing management server 150 can be a computer platform that provides services via a network, such as the Internet, it can use virtual machines that may not correspond to individual hardware. The computational and/or storage capabilities can be implemented by allocating appropriate portions of desirable computation/storage power from a scalable repository, such as a data center and/or a distributed computing environment.

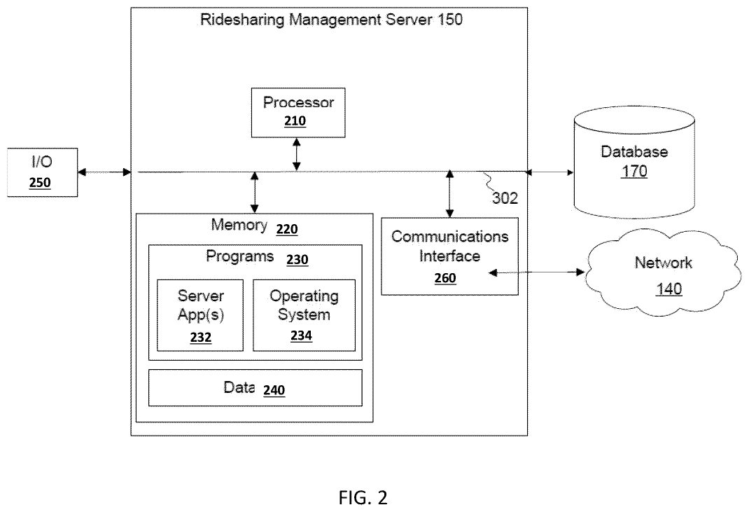

Turning to FIG. 2, FIG. 2 shows an example of an architecture for a ridesharing management server 150, according to some embodiments of the invention. The ridesharing management server 150 can include a processor 210 may be one or more processing devices configured to perform functions of the disclosed methods, such as a microprocessor manufactured by Intel™ or manufactured by AMD™. Processor 210 can include a single core or multiple core processors executing parallel processes simultaneously. For example, processor 210 may be a single core processor with virtual processing technologies. In some embodiments, processor 210 can use logical processors to simultaneously execute and/or control multiple processes. Processor 210 can implement virtual machine technologies, and/or other technologies to provide the ability to execute, control, run, manipulate, and/or store multiple software processes, applications, programs. In some embodiments, processor 210 includes a multiple-core processor arrangement (e.g., dual and/or quad core) to provide parallel processing functionalities to allow ridesharing management server 150 to execute multiple processes simultaneously. It is appreciated by one of ordinary skill in the art that other types of processor arrangements can be implemented that provide for the capabilities disclosed herein.

Memory 220 can be a volatile or non-volatile, magnetic, semiconductor, tape, optical, removable, non-removable, or other type of storage device or tangible or non-transitory computer-readable medium that stores one or more program(s) 230 such as server apps 232 and operating system 234, and data 240. Common forms of non-transitory media include, for example, a flash drive, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM or any other flash memory, NVRAM, a cache, a register, any other memory chip or cartridge, and networked versions of the same.

The ridesharing management server (e.g., ridesharing management server 150 as described above in FIG. 1) can include one or more storage devices configured to store information used by processor 210 (or other components) to perform certain functions related to the embodiments. For example, the ridesharing management server may include memory 220 that includes instructions to enable processor 210 to execute one or more applications, such as server apps 232, operating system 234, and/or any other type of application or software known to be available on computer systems. In some embodiments, the instructions, and/or application programs, can be stored in an external database 170, which in some embodiments, is internal to ridesharing management server 150, or external storage communicatively coupled with ridesharing management server 150 (not shown), such as one or more database or memory accessible over network 140.

Database 170 or other external storage may be a volatile or non-volatile, magnetic, semiconductor, tape, optical, removable, non-removable, or other type of storage device or tangible or non-transitory computer-readable medium. Memory 220 and database 170 may include one or more memory devices that store data and instructions used to perform one or more features of the disclosed embodiments. Memory 220 and database 170 may also include any combination of one or more databases controlled by memory controller devices (e.g., server(s), etc.) or software, such as document management systems, Microsoft SQL databases, SharePoint databases, Oracle™ databases, Sybase™ databases, or other relational databases.

In some embodiments, ridesharing management server 150 is communicatively connected to one or more remote memory devices (e.g., remote databases (not shown)) through network 140 or a different network. The remote memory devices can be configured to store information that ridesharing management server 150 can access and/or manage. By way of example, the remote memory devices may include document management systems, Microsoft SQL database, SharePoint databases, Oracle™ databases, Sybase™ databases, or other relational databases. Systems and methods consistent with disclosed embodiments, however, are not limited to separate databases or even to the use of a database.

Programs 230 may include one or more software modules causing processor 210 to perform one or more functions of the disclosed embodiments. Processor 210 may execute one or more programs located remotely from one or more components of the ridesharing management system 100. For example, ridesharing management server 150 may access one or more remote programs that, when executed, perform functions related to disclosed embodiments.

In some embodiments, server app(s) 232 may cause processor 210 to perform one or more functions of the disclosed methods. For example, devices associated with users, drivers and autonomous vehicles may respectively be installed with user applications for vehicle ridesharing services, and driver applications for vehicle ridesharing services. Further, a mobile communications device may be installed with both the driver applications and the user applications, for uses in corresponding situations.

In some embodiments, other components of ridesharing management system 100 may be configured to perform one or more functions of the disclosed methods. For example, mobile communications devices 120 may be configured to calculate estimate pick-up and drop-off times based on a certain ride request and may be configured to calculate estimate ride fares. As another example, mobile communications devices 120 may further be configured to provide navigation service, and location service, such as directing the user to a particular pick-up or drop-off location and providing information about a current location of the respective user or vehicle to ridesharing management server 150.

In some embodiments, program(s) 230 may include operating system 234 performing operating system functions when executed by one or more processors such as processor 210. By way of example, operating system 234 may include Microsoft Windows™, Unix™, Linux™, Apple™ operating systems, Personal Digital Assistant (PDA) type operating systems, such as Apple iOS, Google Android, Blackberry OS, Microsoft CE™, or other types of operating systems. Accordingly, the disclosed embodiments may operate and function with computer systems running any type of operating system 234. Ridesharing management server 150 may also include software that, when executed by a processor, provides communications with network 140 through communications interface 260 and/or a direct connection to one or more user devices 120. Specifically, communications interface 260 may be configured to receive ride requests (e.g., from user devices 120A-120C) headed to differing destinations, or a volume of ride requests and receive indications of the current locations of the ridesharing vehicles (e.g., from driver devices 120D and 120E or driving-control device 120F). In one example, communications interface 260 may be configured to continuously or periodically receive current vehicle location data for the plurality of ridesharing vehicles that are part of ridesharing management system 100. The current vehicle location data may include global navigation satellite system (GNSS) data and/or local navigation satellite system data generated by at least one GNSS component of a mobile communications device 120 associated with each ridesharing vehicle. The GNSS data can include Global Positioning System (GPS), GLONASS, Galileo, or any GNSS system as is known in the art.

In some embodiments, data 240 may include, for example, profiles of users, such as user profiles or driver profiles. User profiles can include contact information, profile photos, user account information and/or associated mobile communications device information. Rider account information can include ride history, service feedback, complaints, and/or comments. Driver account information can include number of ride service assignments completed, ratings, ride service history, rider ride history, driver service record, and/or communications between a driver and a rider regarding a particular ride request. In some embodiments, data 240 may further include traffic data, toll road information, and navigation information, which may be used for handling and accommodating ride requests.

Automated ridesharing dispatch system 300 may also include one or more I/O devices 250 having one or more interfaces for receiving signals or input from devices and providing signals or output to one or more devices that allow data to be received and/or transmitted by automated ridesharing dispatch system 300. For example, automated ridesharing dispatch system 300 may include interface components for interfacing with one or more input devices, such as one or more keyboards, mouse devices, and the like, that enable automated ridesharing dispatch system 300 to receive input from an operator or administrator (not shown).

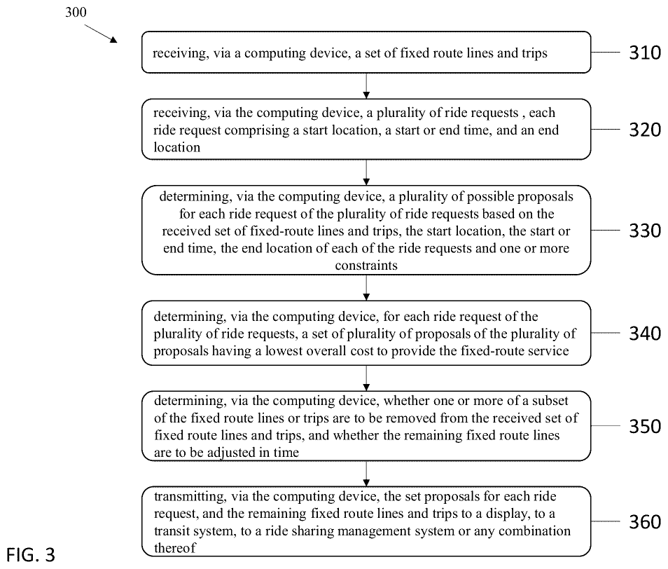

FIG. 3 shows a flowchart for a method for planning a public transit system comprising determining costs of providing a fixed route service, according to some embodiments of the invention.

The method can involve receiving, via a computing device (e.g., user device 120C as described above in FIG. 1), a set of fixed route lines for a particular public transit system (Step 310). For example, a transit planner (e.g., a system or an individual) can transmit a set of fixed routes (e.g., routes that shared public vehicles travel over in a geographical area). Fixed routes can be bus routes, van routes, shared vehicle routes, trams, ferries, light rails, and/or heavy rails. As is apparent to one of ordinary skill in the art, the fixed routes can be any route that is fixed that do not change as more ride requests are made. In various embodiments, the fixed routes can be input through a user interface and/or as a table. In some embodiments, the fixed routes can be in accordance with the General Transit Feed Specification (GTFS).

The method can involve receiving, via the computing device, a plurality of ride requests, each ride request comprising a start location, a start or end time, and an end location (Step 320). The ride request can be input through a user interface, as a log file, a table or any combination thereof. The size of the plurality of ride requests can depend on population size and/demand for transit in the area. The size of the plurality of ride requests can be from hundreds to hundred of thousands, or any number.

In some embodiments, the plurality of ride requests is previous real world rides that were taken in the transit system. In some embodiments, the plurality of ride requests are upcoming requests. In some embodiments, the plurality of ride requests is generated by a statistical model or AI. Each of the plurality of requests can have a start location, a start or end time and an end location. The start location and the end location can be positioned at any location.

An example of the plurality of ride requests can be shown below in Table 1.

TABLE 1

| | | | | | Desting. |
|---|---|---|---|---|---|
| Request Id | Time | Origin Lat. | Origin Long. | Dest. Lat. | Long |
| 0 | 08:15:00 | 43.542434 | −96.719429 | 43.545990 | −96.733960 |
| 1 | 07:39:00 | 43.527495 | −96.685568 | 43.536670 | −96.745009 |
| 2 | 08:30:00 | 43.529543 | −96.715019 | 43.5433453 | −96.727989 |
| 3 | 06:00:00 | 43.522107 | −96.761928 | 43.496835 | −96.744248 |
| 4 | 07:00:00 | 43.524684 | −96.710645 | 43.550643 | −96.763660 |
| 5 | 07:55:00 | 43.551161 | −96.745438 | 43.585517 | −96.722947 |
| 6 | 07:45:00 | 43.510260 | −96.808754 | 43.506789 | −96.738638 |

As shown in Table 1, each of the plurality of ride requests can have a request identifier (e.g., Request Id), a start time (e.g., Time), an origin point expressed in latitude, longitude coordinates (e.g., Origin Lat., Origin Long.), a destination point expressed in a latitude, longitude coordinates (e.g., Dest. Lat., Dest. Long.). In the example in Table 1, each ride request has a start time. In some embodiments, each ride request, instead of a start time has a finish time.

The method can involve determining, via the computing device, a plurality of possible proposals for each ride request of the plurality of ride requests based on the received set of fixed route lines, the start location, the start or end time, the end location of each of the ride requests and one or more constraints (Step 330). The possible proposals can be determined by any transit route planner, such as Google Maps, City Mapper or open source programs such as Open Trip Planner. In some embodiments, the set of fixed route lines is determined within the one or more constraints specified for each ride request, all possible fixed route vehicles (e.g., buses or vans) that can serve the particular ride request. For example, assume a first ride request and second ride request are in the plurality of ride requests, and a fixed-line system having buses A, B, C, D. The general solver can determine that the first ride request can take buses A, B, and D, and the second ride request can take bus B, C, and D. Thus, in this example, the possible solutions for the first ride request are A, B, and D, and the possible solutions for the second ride request are B, C, and D. As is apparent to one of ordinary skill in the art, this example is simplistic and for illustrative purposes only. There can be on the order of tens of thousands of ride request or more in any given transit planning request, where the transit system can have thousands of bus strips.

Each proposal can be a single leg or multi-leg trip. Each proposal can include quality of service (QOS) requirements. For example, a limit on the walking distance, a preference for shorter overall transit duration over restricting number of legs or vice versa. The QoS requirements can be input by a user. The QoS requirements can depend on a particular user, service provider and/or any combination thereof. The QoS requirements can include limit the walking distance from origin to pick-up location or destination to drop-off location to be less than a predetermined number of kilometers (e.g., 2 km), limiting the number of swaps needed to a predetermined number (e.g., 3), limit the wait time for pickup to a predetermine duration (e.g., 1 hour) or any combination thereof.

The one or more constraints can be a number of assignments per trip does not exceed a predetermined limit per trip, if a trip is assigned to a request, then a corresponding return trip is automatically assigned when the fixed route line operates the same route in two directions, if a trip is assigned to a request, then activate the fixed route line, or any combination thereof.

Each of the plurality of solutions can have a trip duration associated with it, given the capacity limit of the vehicle that runs the trip.

A range of proposals can be generated per each ride request, with minimal or no QoS requirements. Minimizing the QoS requirements can allow more proposals, which can in turn gives more flexibility for the optimization. In some embodiments, the QoS requirements can be prioritized. In some embodiments, if the efficiency goes below a certain level, the QoS requirements can be left out of the planning in according with the prioritization.

The method can involve determining, via the computing device, for each ride request of the plurality of ride requests, a set of proposals of the plurality of proposals having the lowest overall cost to provide the fixed-route service (Step 340).

Determining a cost of providing the fixed route service for each of the plurality of possible proposals can involve a) summing fixed route trip duration multiplied by fixed route trip cost over all fixed route trips; b) summing costs for each fixed route; c) summing for all rides total trip duration multiplied by value of travel time; and d) summing outcomes of a) b) and c).

In some embodiments, proposals can be determined that include an on-demand portion for a ride request. For example, a proposal can include a first portion of the trip is on the public transit bus route, e.g., bus route A, and then a second portion of the trip is executed by an on-demand vehicle (e.g., a ridesharing vehicle that is on call from a pool of ridesharing vehicles in a ridesharing system). In these embodiments, the cost is determined for providing the fixed route service and the on-demand vehicle, as follows a) summing fixed route trip duration multiplied by fixed route trip cost over all fixed route trips; b) summing costs for each fixed route; c) summing on-demand trip durations multiplied by on-demand van time cost over all on-demand trips; d) adding a fixed overhead for operating an On-demand service; e) summing for all rides total trip duration multiplied by value of travel time; and f) summing outcomes of a) b) c) d) and e).

In some embodiments, the proposal is fixed route only. In some embodiments, the proposal is on-demand only.

In some embodiments, an overall cost can be determined. The overall cost can be based on operational cost (e.g., the cost of operating the fixed route service and/or the on-demand-service) and rider's time cost.

The cost of operating the fixed route service may not be impacted by the assignment of a ride to a trip, since as long as the trip is operated its cost is fixed regardless of the capacity it actually carries.

In some embodiments, the cost of a fixed route trip (e.g., bus trip) can be non-linear in the number (or any sum of per-ride costs) of the rides it serves, but rather can behave like a step function depending only on whether any ride was assigned to the fixed route trip. As long as no rides require the operation of a specific fixed route trip, the particular fixed route trip can be deactivated, and its operational cost avoided. Once a ride is assigned to the fixed route trip, the cost of operating the fixed route can be included. In some embodiments, fixed route cost can be the trip duration times an hourly cost of operating a bus.

In various embodiments, additional cost components that are not directly proportional to the operated trip times, but rather penalizes the operation of a fixed route (e.g., overhead of operating a fixed route line), so as to favor a network with fewer lines, as long as the quality of service is preserved.

In some embodiments, for on-demand rides, a machine learning model is used to predict vehicle (e.g., van, car) duration (e.g., for a vehicle used in a proposal) consumed by a ride, based on the ride request (e.g., origin, destination, time-of-day). The vehicle duration can be multiplied by the cost-per-time of a vehicle to calculate a final operational cost.

In some embodiments, the rider's time cost is determined for fixed route ride requests, on-demand ride requests or both. In some embodiments, the rider's time cost for a multiple leg can be immediate to deduce a duration of different components of the trip (e.g., headway, travel durations, waiting durations at transfers and/or walking duration to destination) and summed. The components of a trip can be summed either as is or weighted. The weights can be such that they allow a best chance of capturing the riders' and/or the planner's preferences (for example, walking durations can be penalized more heavily than transit durations etc.).

In some embodiments, the rider's time cost in an on-demand trip, a similar technique to that used for predicting operational cost can be used-predict the total trip duration using a regression model based on request features.

The obtained trip duration can be multiplied by a value-of-travel-time (VTT) to yield the rider time cost.

In some embodiments, the overall cost can be determined as follows in EQN. 1:

$$Cost = {\sum }_{t ∈ \{ operated FR trips \}} {trip\_duration}_{t} \cdot bus\_time \_cost + {\sum }_{l ∈ \{ operated FR lines \}} line\_overhead {\_cost}_{l} + {\sum }_{v ∈ \{ all ODT rides \}} attributed\_van {\_duration}_{v} \cdot od \_van \_time \_cost + od \_overhead \_cost + {\sum }_{r ∈ \{ all rides \}} total\_ride {\_duration}_{r} \cdot value\_of \_rider \_time \qquad EQN 1$$

where: trip_duration is the duration of a specific trip in a fixed route line; bus_time_cost is an operational cost of driving the fixed route vehicle (e.g. bus, van etc.); line_overhead_cost: the cost of having a fixed route line operated, regardless of the number of trips; attributed_van_duration: total time that vehicles that are optionally assigned to requests need to operate; od_van_time_cost: the operational cost of driving an on-demand vehicle; od_overhead_cost: the overhead cost of having an on-demand service operational; total_ride_duration: the total ride duration for the ride requests in the demand scenario based on the proposal assigned to them (e.g., fixed route or on-demand), which can include walking time, waiting time and/or transit time; and value_of_rider_time: an estimation of the value of the riders' time

As is apparent to one of ordinary skill in the art, for proposals that have no on-demand portions, the on-demand term is zero.

In some embodiments, for on-demand trips, a constant value can be used in the overall cost determination. The constant value can be a default value, and/or input by a user.

In some embodiments, an optimal proposal for each ride can be determined. The optimal proposal can be a set of proposals, one for each ride, that minimize the overall cost.

The method can involve determining, via the computing device, whether one or more of a subset of the fixed route lines or trips are to be removed from the received set of fixed route lines and trips, and whether the remaining fixed route trips are to be adjusted in time (Step 350).

The method can involve transmitting, via the computing device, the proposal for each ride request to a display, to a transit system, to a ride sharing management system or any combination thereof (Step 350).

In some embodiments, where on-demand vehicles are used, the proposals for each ride request can be used to determine a vehicle fleet size necessary to service the plurality of ride requests.

In some embodiments, there is a post-process stage in which trips schedules are re-spaced in order to assure a simple frequency schedule. For example, if it is proposed to reduce one trip per hour for a bus line with four evenly spaced hourly trips, the remaining three trips of each hour can be re-spaced so the resulting schedule remains evenly spaced (e.g., a trip every 20 minutes instead of varying time differences).

In some embodiments, variations to the bus routes are determined by modifying the fixed-routes, for example, trimming routes at ends, shortcutting low demand sections, and/or slight route adjustments.

In some embodiments updates to the public transit system timetables (e.g., fixed route times) and/or vehicle frequency can be output. For example, an updated version of a GTFS can be transmitted, which reflects the changes in fixed route timetables.

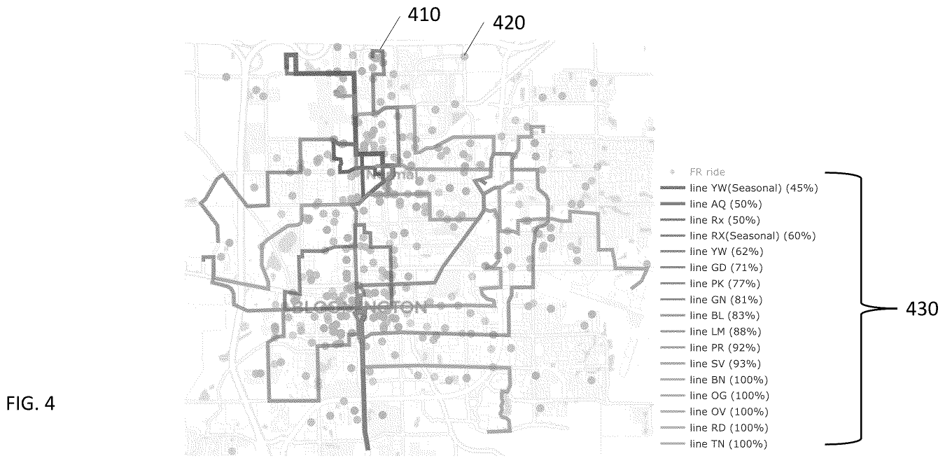

FIG. 4 is a diagram showing an example of an output with fixed route only according to some embodiments of the invention. As show in FIG. 4, each dot 420 is a ride request, and each line 410 is a portion of a fixed route. As seen in FIG. 4, legend 430 shows how many trips were retained from the original number of trips in the service per line.

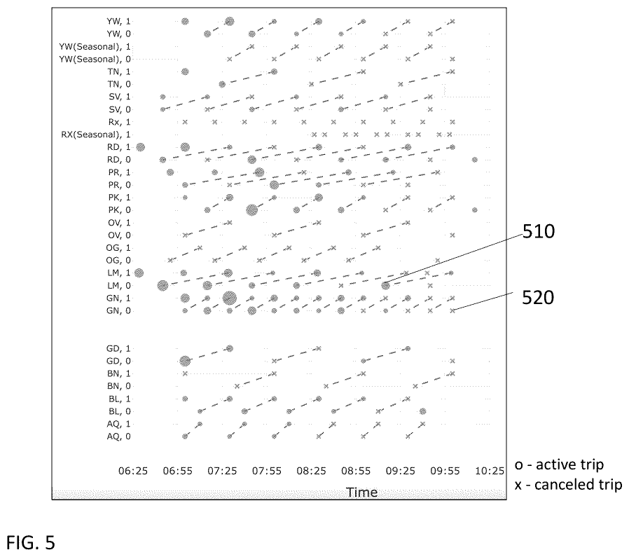

FIG. 5 is a diagram showing an example of an output with fixed route only according to some embodiments of the invention. The diagram shows at each time solid dots 510 whether a trip was operated on a particular fixed route, and radius of the dot 510 indicates a number of rides assigned to the trip. The x's 520 are solid dots that were removed from the trips.

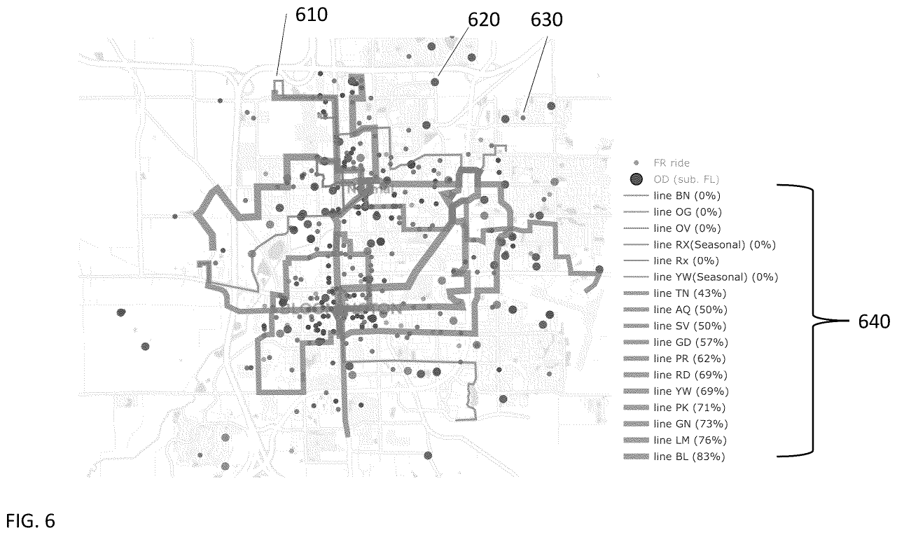

FIG. 6 is a diagram showing an example of an output with fixed route and on-demand according to some embodiments of the invention. The diagram shows at each time big solid dots 612 whether a trip was operated on a particular fixed route and small solid dots 630 whether a trip was operated as an on-demand trip, and each line 610 is a portion of fixed route.

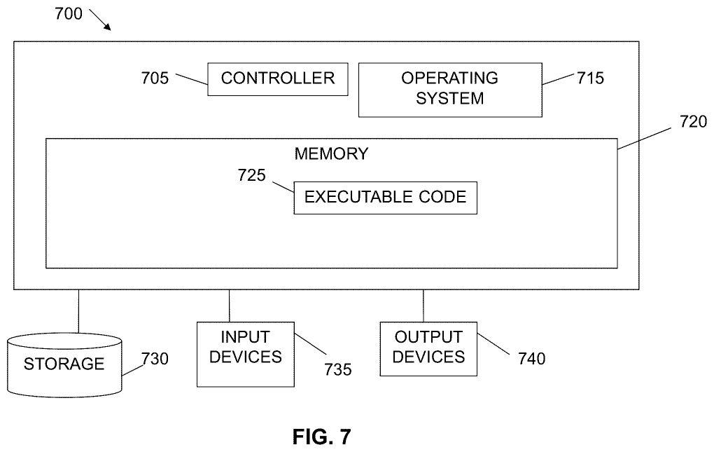

FIG. 7 shows a block diagram of a computing device 700 which can be used with embodiments of the invention. Computing device 700 can include a controller or processor 705 that can be or include, for example, one or more central processing unit processor(s) (CPU), one or more Graphics Processing Unit(s) (GPU or GPGPU), a chip or any suitable computing or computational device, an operating system 715, a memory 720, a storage 730, input devices 735 and output devices 740.

Operating system 715 can be or can include any code segment designed and/or configured to perform tasks involving coordination, scheduling, arbitration, supervising, controlling or otherwise managing operation of computing device 700, for example, scheduling execution of programs. Memory 720 can be or can include, for example, a Random Access Memory (RAM), a read only memory (ROM), a Dynamic RAM (DRAM), a Synchronous DRAM (SD-RAM), a double data rate (DDR) memory chip, a Flash memory, a volatile memory, a non-volatile memory, a cache memory, a buffer, a short term memory unit, a long term memory unit, or other suitable memory units or storage units. Memory 720 can be or can include a plurality of possibly different memory units. Memory 720 can store, for example, instructions to carry out a method (e.g. code 725), and/or data such as user responses, interruptions, etc.

Executable code 725 can be any executable code, e.g., an application, a program, a process, task or script. Executable code 725 can be executed by controller 705 possibly under control of operating system 715. For example, executable code 725 can when executed cause masking of personally identifiable information (PII), according to embodiments of the invention. In some embodiments, more than one computing device 700 or components of device 700 can be used for multiple functions described herein. For the various modules and functions described herein, one or more computing devices 700 or components of computing device 700 can be used. Devices that include components similar or different to those included in computing device 700 can be used and can be connected to a network and used as a system. One or more processor(s) 705 can be configured to carry out embodiments of the invention by, for example executing software or code. Storage 730 can be or can include, for example, a hard disk drive, a floppy disk drive, a Compact Disk (CD) drive, a CD-Recordable (CD-R) drive, a universal serial bus (USB) device or other suitable removable and/or fixed storage unit. Data such as instructions, code, NN model data, parameters, etc. can be stored in a storage 730 and can be loaded from storage 730 into a memory 720 where it can be processed by controller 705. In some embodiments, some of the components shown in FIG. 7 can be omitted.

Input devices 735 can be or can include for example a mouse, a keyboard, a touch screen or pad or any suitable input device. It will be recognized that any suitable number of input devices can be operatively connected to computing device 700 as shown by block 735. Output devices 740 can include one or more displays, speakers and/or any other suitable output devices. It will be recognized that any suitable number of output devices can be operatively connected to computing device 700 as shown by block 740. Any applicable input/output (I/O) devices can be connected to computing device 700, for example, a wired or wireless network interface card (NIC), a modem, printer or facsimile machine, a universal serial bus (USB) device or external hard drive can be included in input devices 735 and/or output devices 740.

Embodiments of the invention can include one or more article(s) (e.g. memory 720 or storage 730) such as a computer or processor non-transitory readable medium, or a computer or processor non-transitory storage medium, such as for example a memory, a disk drive, or a USB flash memory, encoding, including or storing instructions, e.g., computer-executable instructions, which, when executed by a processor or controller, carry out methods disclosed herein.

One skilled in the art will realize the invention can be embodied in other specific forms without departing from the spirit or essential characteristics thereof. The foregoing embodiments are therefore to be considered in all respects illustrative rather than limiting of the invention described herein. Scope of the invention is thus indicated by the appended claims, rather than by the foregoing description, and all changes that come within the meaning and range of equivalency of the claims are therefore intended to be embraced therein.

In the foregoing detailed description, numerous specific details are set forth in order to provide an understanding of the invention. However, it will be understood by those skilled in the art that the invention can be practiced without these specific details. In other instances, well-known methods, procedures, and components, modules, units and/or circuits have not been described in detail so as not to obscure the invention. Some features or elements described with respect to one embodiment can be combined with features or elements described with respect to other embodiments.

Although embodiments of the invention are not limited in this regard, discussions utilizing terms such as, for example, “processing,” “computing,” “calculating,” “determining,” “establishing”, “analyzing”, “checking”, or the like, can refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium that can store instructions to perform operations and/or processes.

Although embodiments of the invention are not limited in this regard, the terms “plurality” and “a plurality” as used herein can include, for example, “multiple” or “two or more”. The terms “plurality” or “a plurality” can be used throughout the specification to describe two or more components, devices, elements, units, parameters, or the like. The term set when used herein can include one or more items. Unless explicitly stated, the method embodiments described herein are not constrained to a particular order or sequence. Additionally, some of the described method embodiments or elements thereof can occur or be performed simultaneously, at the same point in time, or concurrently.

A computer program can be written in any form of programming language, including compiled and/or interpreted languages, and the computer program can be deployed in any form, including as a stand-alone program or as a subroutine, element, and/or other unit suitable for use in a computing environment. A computer program can be deployed to be executed on one computer or on multiple computers at one site.

Method steps can be performed by one or more programmable processors executing a computer program to perform functions of the invention by operating on input data and generating output. Method steps can also be performed by an apparatus and can be implemented as special purpose logic circuitry. The circuitry can, for example, be a FPGA (field programmable gate array) and/or an ASIC (application-specific integrated circuit). Modules, subroutines, and software agents can refer to portions of the computer program, the processor, the special circuitry, software, and/or hardware that implement that functionality.

Processors suitable for the execution of a computer program include, by way of example, both general and special purpose microprocessors, and any one or more processors of any kind of digital computer. Generally, a processor receives instructions and data from a read-only memory or a random-access memory or both. The essential elements of a computer are a processor for executing instructions and one or more memory devices for storing instructions and data. Generally, a computer can be operatively coupled to receive data from and/or transfer data to one or more mass storage devices for storing data (e.g., magnetic, magneto-optical disks, or optical disks).

Data transmission and instructions can also occur over a communications network. Information carriers suitable for embodying computer program instructions and data include all forms of non-volatile memory, including by way of example semiconductor memory devices. The information carriers can, for example, be EPROM, EEPROM, flash memory devices, magnetic disks, internal hard disks, removable disks, magneto-optical disks, CD-ROM, and/or DVD-ROM disks. The processor and the memory can be supplemented by, and/or incorporated in special purpose logic circuitry.

To provide for interaction with a user, the above-described techniques can be implemented on a computer having a display device, a transmitting device, and/or a computing device. The display device can be, for example, a cathode ray tube (CRT) and/or a liquid crystal display (LCD) monitor. The interaction with a user can be, for example, a display of information to the user and a keyboard and a pointing device (e.g., a mouse or a trackball) by which the user can provide input to the computer (e.g., interact with a user interface element). Other kinds of devices can be used to provide for interaction with a user. Other devices can be, for example, feedback provided to the user in any form of sensory feedback (e.g., visual feedback, auditory feedback, or tactile feedback). Input from the user can be, for example, received in any form, including acoustic, speech, and/or tactile input.

The computing device can include, for example, a computer, a computer with a browser device, a telephone, an IP phone, a mobile device (e.g., cellular phone, personal digital assistant (PDA) device, laptop computer, electronic mail device), and/or other communication devices. The computing device can be, for example, one or more computer servers. The computer servers can be, for example, part of a server farm. The browser device includes, for example, a computer (e.g., desktop computer, laptop computer, and tablet) with a World Wide Web browser (e.g., Microsoft® Internet Explorer® available from Microsoft Corporation, Chrome available from Google, Mozilla® Firefox available from Mozilla Corporation, Safari available from Apple). The mobile computing device includes, for example, a personal digital assistant (PDA).

Website and/or web pages can be provided, for example, through a network (e.g., Internet) using a web server. The web server can be, for example, a computer with a server module (e.g., Microsoft® Internet Information Services available from Microsoft Corporation, Apache Web Server available from Apache Software Foundation, Apache Tomcat Web Server available from Apache Software Foundation).

The storage module can be, for example, a random access memory (RAM) module, a read only memory (ROM) module, a computer hard drive, a memory card (e.g., universal serial bus (USB) flash drive, a secure digital (SD) flash card), a floppy disk, and/or any other data storage device. Information stored on a storage module can be maintained, for example, in a database (e.g., relational database system, flat database system) and/or any other logical information storage mechanism.

The above-described techniques can be implemented in a distributed computing system that includes a back-end component. The back-end component can, for example, be a data server, a middleware component, and/or an application server. The above-described techniques can be implemented in a distributing computing system that includes a front-end component. The front-end component can, for example, be a client computer having a graphical user interface, a Web browser through which a user can interact with an example implementation, and/or other graphical user interfaces for a transmitting device. The components of the system can be interconnected by any form or medium of digital data communication (e.g., a communication network). Examples of communication networks include a local area network (LAN), a wide area network (WAN), the Internet, wired networks, and/or wireless networks.

The system can include clients and servers. A client and a server are generally remote from each other and typically interact through a communication network. The relationship of client and server arises by virtue of computer programs running on the respective computers and having a client-server relationship to each other.

The above-described networks can be implemented in a packet-based network, a circuit-based network, and/or a combination of a packet-based network and a circuit-based network. Packet-based networks can include, for example, the Internet, a carrier internet protocol (IP) network (e.g., local area network (LAN), wide area network (WAN), campus area network (CAN), metropolitan area network (MAN), home area network (HAN), a private IP network, an IP private branch exchange (IPBX), a wireless network (e.g., radio access network (RAN), 802.11 network, 802.16 network, general packet radio service (GPRS) network, HiperLAN), and/or other packet-based networks. Circuit-based networks can include, for example, the public switched telephone network (PSTN), a private branch exchange (PBX), a wireless network (e.g., RAN, Bluetooth®, code-division multiple access (CDMA) network, time division multiple access (TDMA) network, global system for mobile communications (GSM) network), and/or other circuit-based networks.

Some embodiments of the present invention may be embodied in the form of a system, a method or a computer program product. Similarly, some embodiments may be embodied as hardware, software or a combination of both. Some embodiments may be embodied as a computer program product saved on one or more non-transitory computer readable medium (or media) in the form of computer readable program code embodied thereon. Such non-transitory computer readable medium may include instructions that when executed cause a processor to execute method steps in accordance with embodiments. In some embodiments the instructions stores on the computer readable medium may be in the form of an installed application and in the form of an installation package.

Such instructions may be, for example, loaded by one or more processors and get executed. For example, the computer readable medium may be a non-transitory computer readable storage medium. A non-transitory computer readable storage medium may be, for example, an electronic, optical, magnetic, electromagnetic, infrared, or semiconductor system, apparatus, or device, or any combination thereof.

Computer program code may be written in any suitable programming language. The program code may execute on a single computer system, or on a plurality of computer systems.

One skilled in the art will realize the invention may be embodied in other specific forms without departing from the spirit or essential characteristics thereof. The foregoing embodiments are therefore to be considered in all respects illustrative rather than limiting of the invention described herein. Scope of the invention is thus indicated by the appended claims, rather than by the foregoing description, and all changes that come within the meaning and range of equivalency of the claims are therefore intended to be embraced therein.

In the foregoing detailed description, numerous specific details are set forth in order to provide an understanding of the invention. However, it will be understood by those skilled in the art that the invention can be practiced without these specific details. In other instances, well-known methods, procedures, and components, modules, units and/or circuits have not been described in detail so as not to obscure the invention. Some features or elements described with respect to one embodiment can be combined with features or elements described with respect to other embodiments.

1. A method for planning a public transit system comprising determining costs of providing a fixed-route service, the method comprising:
receiving, via a computing device, a set of fixed route lines and trips for a particular public transit system;
receiving, via the computing device, a plurality of ride requests, each ride request comprising a start location, a start or end time, and an end location;
determining, via the computing device, a plurality of possible proposals for each ride request of the plurality of ride requests based on the received set of fixed route lines and trips, the start location, the start time, the end location of each of the ride requests and one or more constraints;
determining, via the computing device, for each ride request of the plurality of ride requests, a set of proposals of the plurality of proposals having the lowest overall cost to provide the fixed-route service;
determining, via the computing device, whether one or more of a subset of the fixed route lines or trips are to be removed from the received set of fixed route lines and trips, and whether the remaining fixed route lines and trips are to be adjusted in time; and
transmitting, via the computing device, the set proposals for each ride request, and the remaining fixed route lines and trips to a display, to a transit system, to a ride sharing management system or any combination thereof.

2. The method of claim 1 further comprising outputting the public transit system timetables, vehicle frequency, or any combination thereof.

3. The method of claim 1 wherein the one or more constraints include a number of assignments per trip does not exceed a predetermined limit per trip, if a trip is assigned to a request, then a corresponding return trip is automatically assigned when the fixed route line operates the same route in two directions, if a trip is assigned to a request, then activate the fixed route line, or any combination thereof.

4. The method of claim 1 wherein determining, the set of proposals for each request further comprises using a mixed integer linear program based on the plurality of solutions.

5. The method of claim 1 wherein determining the overall cost comprises:
a) summing fixed route trip durations multiplied by fixed route trip's total operational cost over all fixed route trips used;
b) summing costs for each fixed-route;
c) summing for all rides total trip duration multiplied by value of travel time; and
d) summing outcomes of a) b) and c).

6. The method of claim 1 further comprising:
determining for at least some of the ride requests an on-demand proposal;
determining a cost of providing the proposals for each ride request based on the fixed-service proposal and the on-demand proposal; and
selecting one proposal of the plurality of proposals based on the overall cost.

7. The method of claim 6 wherein determining the cost of the fixed-route and on-demand proposals comprises:
a) summing fixed route trip duration multiplied by fixed route trip's total operational cost over all fixed route trips used;
b) summing costs for each fixed route;
c) summing on-demand trip durations multiplied by on-demand van time cost over all on-demand trips, and adding an overhead for operating an on-demand service;
d) summing for all rides total trip duration multiplied by value of travel time; and
e) summing outcomes of a) b) c) and d).

8. A system for planning a public transit system comprising determining costs of providing a fixed-route service, the system comprising:
at least one processor configured to:
receive a set of fixed route lines and trips for a particular public transit system;
receive a plurality of ride requests, each ride request comprising a start location, a start or end time, and an end location;
determine a plurality of possible proposals for each ride request of the plurality of ride requests based on the received set of fixed route lines and trips, the start location, the start time, the end location of each of the ride requests and one or more constraints;
determine for each ride request of the plurality of ride requests, a set of proposals of the plurality of proposals having the lowest overall cost to provide the fixed-route service;
determine whether one or more of a subset of the fixed route lines or trips are to be removed from the received set of fixed route lines and trips, and whether the remaining fixed route lines and trips are to be adjusted in time; and
transmit the set proposals for each ride request, and the remaining fixed route lines and trips to a display, to a transit system, to a ride sharing management system or any combination thereof.

9. The system of claim 8 wherein the at least one processor is further configured to output the public transit system timetables, vehicle frequency, or any combination thereof.

10. The system of claim 8 wherein the one or more constraints include a number of assignments per trip does not exceed a predetermined limit per trip, if a trip is assigned to a request, then a corresponding return trip is automatically assigned when the fixed route line operates the same route in two directions, if a trip is assigned to a request, then activate the fixed route line, or any combination thereof.

11. The system of claim 8 wherein the at least one processor is further configured to determine the set of proposals for each request further comprises using a mixed integer linear program based on the plurality of solutions.

12. The system of claim 8 wherein the at least one processor is further configured to determine the overall cost comprises:
a) sum fixed route trip durations multiplied by fixed route trip's total operational cost over all fixed route trips used;
b) sum costs for each fixed-route;
c) sum for all rides total trip duration multiplied by value of travel time; and
d) sum outcomes of a) b) and c).

13. The system of claim 8 wherein the at least one processor is further configured to
determine for at least some of the ride requests an on-demand proposal;
determine a cost of providing the proposals for each ride request based on the fixed-service proposal and the on-demand proposal; and
select one proposal of the plurality of proposals based on the overall cost.

14. The system of claim 13 wherein the at least one processor is further configured to determine the cost of the fixed-route and on-demand proposals comprises:
a) sum fixed route trip duration multiplied by fixed route trip's total operational cost over all fixed route trips used;
b) sum costs for each fixed route;
c) sum on-demand trip durations multiplied by on-demand van time cost over all on-demand trips, and adding an overhead for operating an on-demand service;
d) sum for all rides total trip duration multiplied by value of travel time; and
e) sum outcomes of a) b) c) and d).

15. One or more non-transitory computer-readable storage media comprising instructions that are executable to cause one or more processors to:
receive a set of fixed route lines and trips for a particular public transit system;
receive a plurality of ride requests, each ride request comprising a start location, a start or end time, and an end location;
determine a plurality of possible proposals for each ride request of the plurality of ride requests based on the received set of fixed route lines and trips, the start location, the start time, the end location of each of the ride requests and one or more constraints;
determine for each ride request of the plurality of ride requests, a set of proposals of the plurality of proposals having the lowest overall cost to provide the fixed-route service;
determine whether one or more of a subset of the fixed route lines or trips are to be removed from the received set of fixed route lines and trips, and whether the remaining fixed route lines and trips are to be adjusted in time; and
transmit the set proposals for each ride request, and the remaining fixed route lines and trips to a display, to a transit system, to a ride sharing management system or any combination thereof.
